(19) United States
(12) Patent Application Publication
(10) Pub. No.: US 2025/0301542 A1
(43) Pub. Date: Sep. 25, 2025

(54) Induction Hob

(71) Applicant: Guangdong Willing Technology Corporation, Huizhou (CN)

(72) Inventors: Jingnong Ye, Huizhou (CN); Shifa Luo, Huizhou (CN); Jiulong Wang, Huizhou (CN)

(21) Appl. No.: 18/749,548

(22) Filed: Jun. 20, 2024

(30) Foreign Application Priority Data
Mar. 22, 2024 (CN) 202420575320.9

(51) Int. Cl. H05B 6/12; H05B 1/02

(52) U.S. Cl. CPC H05B 6/1263; H05B 1/0266; H05B 2206/022

(57) ABSTRACT

Disclosed in the present disclosure is a novel induction hob, the structure thereof including a bottom housing, in which the outer sidewall of the bottom housing is a curved wall with vent openings, and the curved wall is able to provide a larger ventilation area of the vent openings without increasing the height of the bottom housing, so that better heat dissipation is achieved and the height of the sidewalls of the bottom housing is also able to be designed to be as small as possible, thereby achieving the lightness and thinness of the induction hob. Combined with the fact that the motherboard, the first fan, and the second fan are spaced around a side of the electromagnetic coil, it leads to a reduction of space occupying the height inside the bottom housing, and further achieves a thin and light design of the induction hob.

### CROSS REFERENCE TO ELATED APPLICATIONS

The present application claims the benefit of Chinese Patent Application No. 2024205753209 filed on Mar. 22, 2024, the contents of which are incorporated herein by reference in their entirety.

### FIELD

The present disclosure relates to the technical field of induction hobs and, particularly, to a novel induction hob.

### BACKGROUND

Induction hobs work on the principle of eddy current heating generated by electromagnetic induction. That is, a magnetic field is generated by passing a current through a coil, and when magnetic induction lines in the magnetic field pass through the bottom of an iron pan, the magnetic induction lines are cut, resulting in countless small eddy currents, which enables the iron atoms in the iron pan to rotate at high speed and generate collision friction to generate heat to directly heat up the food placed in the pan.

Since induction hobs heat the bottom of the pan directly by electromagnetic induction, it is usually necessary to install a heat dissipation structure on the induction hob in order to prevent the electronic components inside the induction hob from shortening the service life of the induction hob due to high temperatures. However, the induction hob on the market is not sufficiently rationalized due to the arrangement of the heat dissipation structure, resulting in a relatively thick induction hob, which is not easy to carry on a trip. Additionally, the waterproof performance of existing induction hobs is not good enough, which affects the service life of induction hobs.

### SUMMARY

An objective of the present disclosure is to provide a novel induction hob to solve the technical problem that the induction hob on the market is not sufficiently rationalized due to the arrangement of the heat dissipation structure, which results in a relatively thick induction hob, which is not easy to carry on a trip and is poor in the waterproof performance.

To achieve the aforementioned objective, provided in the technical solutions of the present disclosure is a novel induction hob, including a front panel, an upper cover, and a bottom housing provided sequentially from top to bottom, in which a sidewall of the bottom housing is gradually extended outwardly to form a curved wall, the curved wall is provided with a plurality of vent openings, an electromagnetic coil is provided within the bottom housing, an inner bottom of the bottom housing is provided with a flange extending vertically upwards around a periphery close to a sidewall of the bottom housing to block water from entering an interior of the bottom housing, a motherboard, a first fan, and a second fan are spaced around a side of the electromagnetic coil, the electromagnetic coil, the motherboard, the first fan, and the second fan are all positioned within a periphery of the flange, both the first fan and the second fan are provided with a first opening facing the electromagnetic coil, respectively, for heat dissipation of the electromagnetic coil, and the first fan is further provided with a second opening facing the motherboard for heat dissipation of the motherboard.

Further, the motherboard is fixedly provided with a heat dissipation sheet, and the heat dissipation sheet is provided on a side of the motherboard proximal to the first fan with the second opening for heat dissipation of the motherboard.

Further, an inner bottom surface of the bottom housing is further fixedly provided with a shield, and a position of the shield corresponds to that of the electromagnetic coil.

Further, a clearance is provided between an inner bottom surface of the bottom housing and a bottom surface of the electromagnetic coil.

Further, the flange is fixedly connected to the curved wall by reinforcing ribs.

Further, the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

Further, a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot-air zone.

Further, the vent opening includes a first air inlet and a first air outlet, the first air inlet is provided at a front side of the bottom housing, the first air outlet is provided at a rear side of the bottom housing, and both the first opening and the second opening are provided facing the first air outlet.

Further, a right sidewall and/or a left sidewall of the bottom housing is fixedly provided with a retainment plate extending vertically upwards, the vent opening is further provided with a second air inlet and a second air outlet, both the second air inlet and the second air outlet are provided on the right sidewall or the left sidewall of the bottom housing, the retainment plate is provided between the second air inlet and the second air outlet so as to divide an interior of the bottom housing into a cold-air zone and a hot-air zone, the second air inlet is positioned in the cold-air zone, and the second air outlet is positioned in the hot-air zone.

Further, the retainment plate is close to the second fan, and the retainment plate is extended from a sidewall of the bottom housing to the first opening of the second fan close to the retainment plate, so that the second fan is positioned in the cold-air zone.

In summary, the technical solutions of the present disclosure provide the beneficial effects as follows:

(1) The outer sidewall of the bottom housing in the present disclosure is a curved wall with vent openings, and the curved wall is able to provide a larger ventilation area for the vent openings without increasing a height of the bottom housing. Therefore, better heat dissipation is achieved while the height of the sidewalls of the bottom housing is designed to be as small as possible, thereby achieving a thinner and lighter induction hob. Combined with the fact that the motherboard, the first fan, and the second fan are spaced around a side of the electromagnetic coil, it leads to a reduction of space occupying the height inside the bottom housing, and further achieves a thin and light design of the induction hob. Moreover, by setting up in cooperation with the first fan and the second fan, efficient heat dissipation of the electromagnetic coil and the motherboard is also achieved.

(2) When the induction hob is placed on a tabletop with a small amount of water, as the height of the sidewall of the bottom housing is designed to be as small as possible and the ventilation area of the vent openings is large, it is easy for the water on the tabletop to be sucked into the interior of the induction hob through the vent openings, for which the present invention is provided with a flange extending vertically upwards around a periphery close to a sidewall of the bottom housing, which may block the water from entering into the interior of the bottom housing to a certain extent, and protects the electrical components inside the induction hob. Therefore, the utility model is not only able to achieve thin design and efficient heat dissipation, but also takes into account good waterproof performance, which is convenient for the user to carry around during outings, and greatly improves the competitiveness of the product.

### BRIEF DESCRIPTION OF THE DRAWINGS

FIG. 1 is a schematic structural diagram in a perspective view of the present invention removing the front panel and the upper cover;

FIG. 2 is a schematic structural diagram in a perspective view of FIG. 1 removing the control board and the power lines.

FIG. 3 is a schematic structural diagram in a perspective view of FIG. 2 removing the heat dissipation sheet;

FIG. 4 is a schematic structural diagram in a perspective view of FIG. 1 with the upper cover mounted;

FIG. 5 is a schematic structural diagram in a perspective view of the present invention;

FIG. 6 is a schematic structural diagram in another perspective view of FIG. 5;

FIG. 7 is a schematic structural diagram in a front view of the present invention;

FIG. 8 is a schematic structural diagram in a top view of the bottom housing in the present invention;

FIG. 9 is a schematic structural diagram in a perspective view of the upper cover in the present invention.

Labels: 1 front panel; 2 upper cover; 201 third partition; 3 bottom housing; 301 retainment plate; 302 first partition; 303 second partition; 4 vent opening; 401 first air inlet; 402 first air outlet; 403 second air inlet; 404 second air outlet; 5 electromagnetic coil; 6 flange; 7 shield; 8 motherboard; 9 first fan; 10 second fan; 11 heat dissipation sheet; 12 control board; 13 reinforcing rib; 14 power line.

### DETAILED DESCRIPTION OF THE EMBODIMENTS

The technical solutions in the embodiments of the present disclosure are clearly and completely described below in conjunction with the accompanying drawings of the present disclosure, but without limiting the scope of the present disclosure.

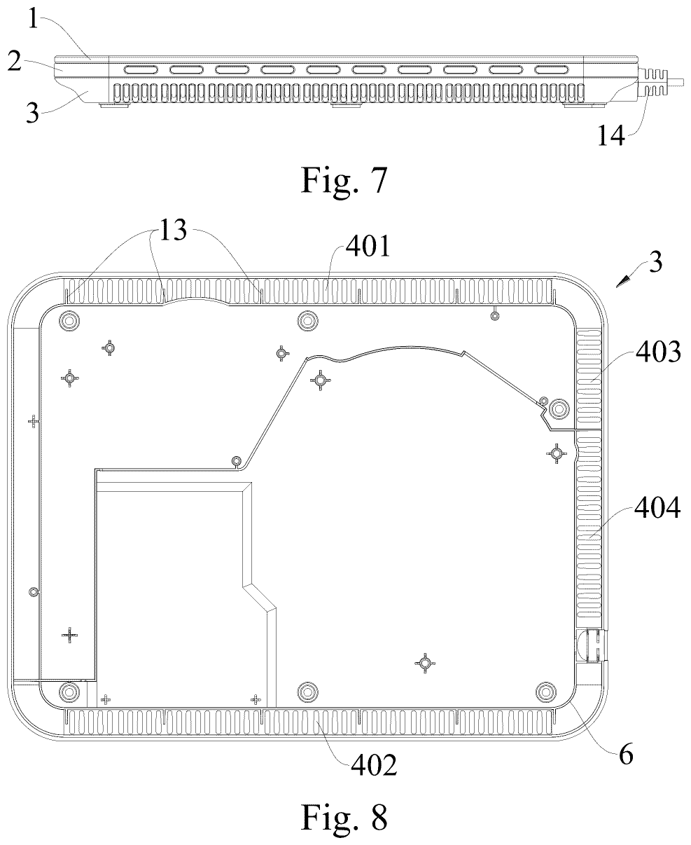

In the present disclosure, the following illustrations are made for better description: the observer faces the accompanying FIG. 7 for observation, the left side of the observer is set to left, the right side of the observer is set to right, the front of the observer is set to front, the back of the observer is set to back, the top of the observer is set to top, and the bottom of the observer is set to bottom. It should be noted that the terms “front,” “back,” “left,” “right,” “center,” “above,” “below,” and the like are used in the text to indicate orientation or positional relationships based on the accompanying drawings only for the purpose of facilitating a clear description of the present disclosure and are not intended to indicate or imply that the structures or parts referred to necessarily have a particular orientation or are constructed in a particular orientation and, therefore, are not to be construed as a limitation of the present disclosure. In addition, the related terms “first”, “second”, “third” and “fourth”, if any, are used solely for purposes of clarity or simplicity of description and are not intended to indicate or imply relative importance or quantity.

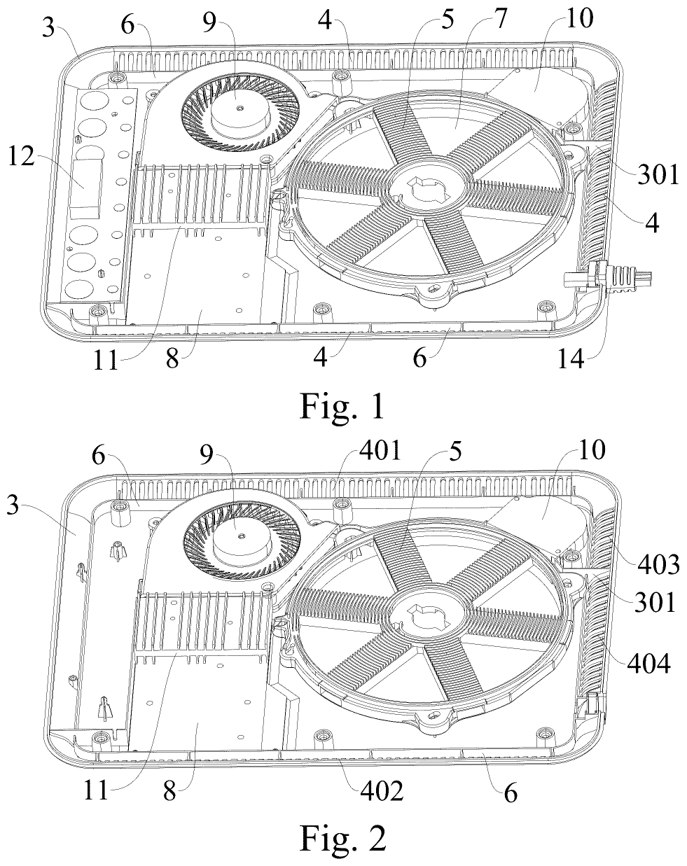

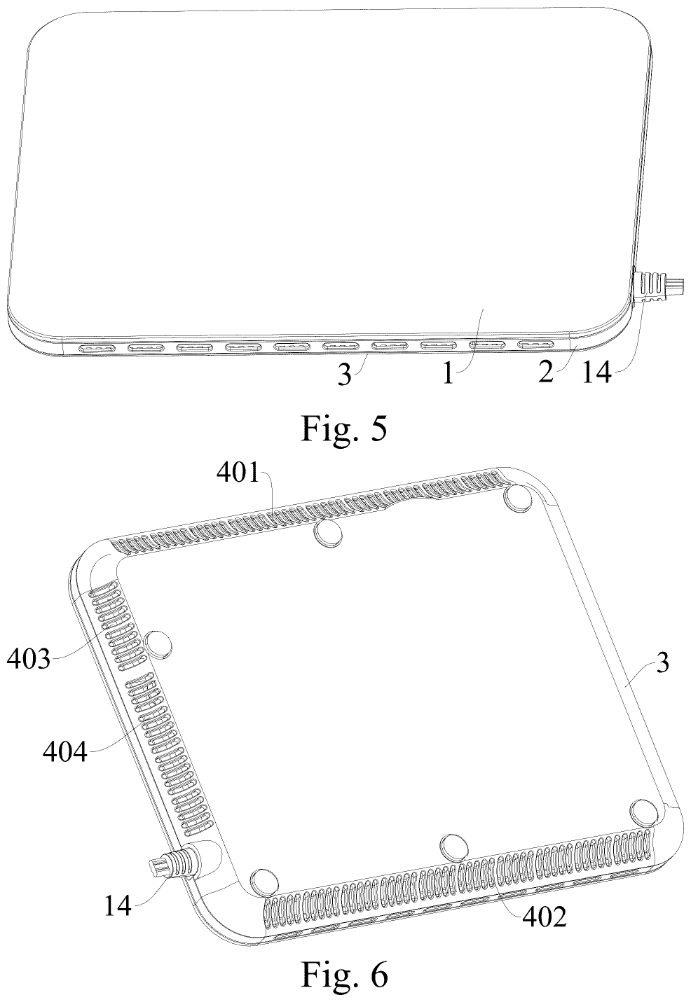

Referring to FIGS. 5 and 7, provided in the present embodiment is a novel induction hob, including a front panel 1, an upper cover 2, and a bottom housing 3 provided sequentially from top to bottom. Referring to FIGS. 1-2, a sidewall of the bottom housing 3 is gradually extended outwardly to form an inwardly concave or outwardly convex curved wall from bottom to top, the curved wall is provided with a plurality of vent openings 4, an electromagnetic coil 5 is provided in a center of the bottom housing 3, a clearance is provided between a bottom of the electromagnetic coil 5 and an inner bottom surface of the bottom housing 3, a bottom of a sidewall of the bottom housing 3 is provided with a flange 6 extending vertically upwards around a periphery of the bottom housing 3 to block water from entering an interior of the bottom housing 3, and the electromagnetic coil 5 is positioned within a periphery of the flange 6. The bottom housing 3 is further fixedly provided with a shield 7, and a position of the shield 7 corresponds to that of the electromagnetic coil 5. A side of the electromagnetic coil 5 is provided with a motherboard 8, a first fan 9 and a second fan 10 spaced apart in a clockwise direction. Both the first fan 9 and the second fan 10 are provided with first openings facing the electromagnetic coil 5, respectively, for heat dissipation of the electromagnetic coil 5. The motherboard 8 is provided on the left side of the electromagnetic coil 5, and the first fan 9 is further provided with a second opening facing the motherboard 8 for heat dissipation of the motherboard 8. Effect: (1) The present invention is provided with vent openings 4 on the outer sidewall of the bottom housing 3, which achieves the heat dissipation of the electromagnetic coil 5 and the motherboard 8 by the cooperative setting with the first fan 9 and the second fan 10. The vent openings 4 of the curved wall is an elongated through-hole extending upwardly from a bottom of the bottom housing 3. Since the curved wall is inwardly concave or outwardly convex, the elongated through-hole is effective to increase the area of the vent openings 4 without increasing the height of the sidewalls of the bottom housing 3, thereby effectively increasing the volume of the air intake. (2) By setting the flange 6, water is blocked from entering the interior of the bottom housing 3 to a certain extent, and the electromagnetic coil 5, the motherboard 8, the first fan 9 and the second fan 10 are all positioned within a periphery of the flange 6, so that the flange 6 provides waterproof protection for the electromagnetic coil 5, the motherboard 8, the first fan 9 and the second fan 10. (3) By means of the shield 7 provided at a bottom of the electromagnetic coil 5, electromagnetic induction between the electromagnetic coil 5 and a metal tabletop used to place the induction hob is blocked to avoid piercing the tabletop and causing a fire. The present invention provides multi-functionality such as heat dissipation, and waterproof. Due to the reasonable layout of the heat dissipation structure, the present invention achieves a thin design, which is convenient for the user to carry around during outings, and greatly improves the competitiveness of the product.

Specifically, referring to FIG. 2, the motherboard 8 is fixedly provided with a heat dissipation sheet 11, and the heat dissipation sheet 11 is provided on a side of the motherboard 8 proximal to the first fan 9 for heat dissipation of the motherboard 8. Effect: (1) By providing the heat dissipation sheet 11 on the motherboard 8, a part of the heat of the motherboard 8 may be transferred to the dispersed heat dissipation sheet 11, and this part of the heat may be brought out of the interior of the bottom housing 3 with the air sprayed out of the second opening to achieve the heat dissipation effect. (2) The heat of the motherboard 8 may also be brought out of the interior of the bottom housing 3 directly by the flowing air of the second opening.

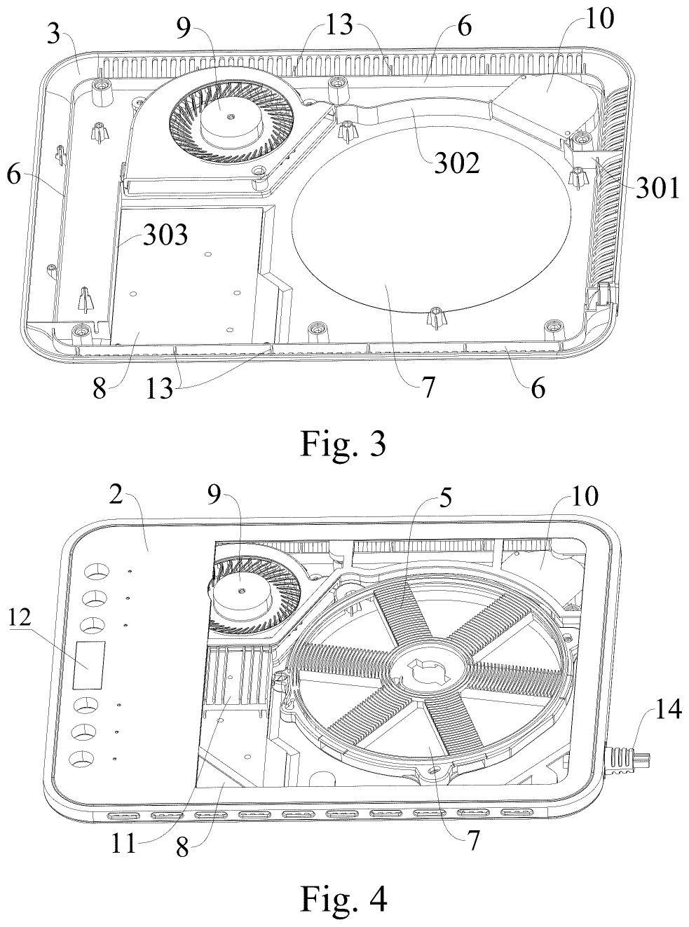

Specifically, referring to FIGS. 3 and 8, the bottom housing 3 is also fixedly provided with a control board 12 inside the bottom housing 3, the control board 12 is provided on the left side of the motherboard 8, the control board 12 is provided on the left side of the flange 6, and the flange 6 is fixedly connected to the curved wall by a reinforcing rib 13. In practice, if there is water on a side of the induction hob, due to the functional characteristics of the fan, it is inevitable to suck the external air into the interior of the bottom housing 3 without sucking in the external water, the present invention may effectively block the water from entering into the bottom housing 3 to a certain extent by the setting of the flange 6. By setting the reinforcing rib 13, the support between the outer wall of the bottom housing 3 and the flange 6 is enhanced.

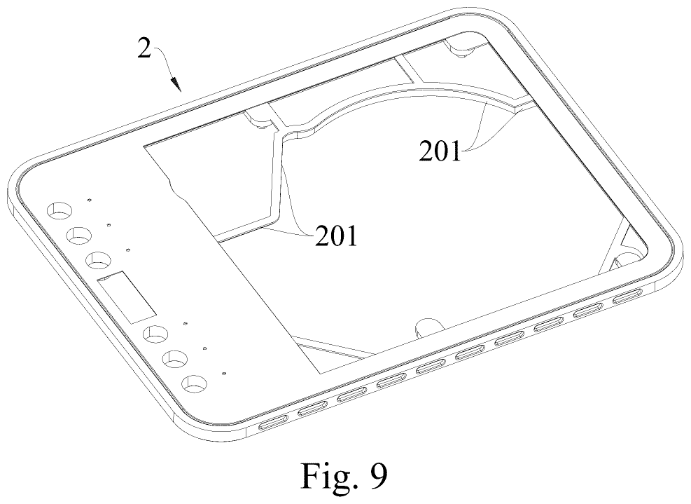

Specifically, referring to FIGS. 3, 4, and 9, the bottom housing 3 is fixedly provided with a first partition 302 and a second partition 303 extending vertically upwards, the first partition 302 is provided between the first fan 9 and the second fan 10, the second partition 303 is provided between the control board 12 and the motherboard 8, a side of the upper cover 2 facing the bottom housing 3 is fixedly provided with a third partition 201 extending vertically downwards, a position of the third partition 201 corresponds to those of the first partition 302 and the second partition 303 to separate a cold-air zone and a hot-air zone, the first fan 9, the second fan 10, and the control board 12 are positioned in the cold-air zone, and the motherboard 8 and the electromagnetic coil 5 are positioned in the hot-air zone.

In practice, by setting the first partition 306, the second partition 307, and the third partition 202, the first fan 9, the second fan 10, and the control board 12 are positioned in the cold-air zone, the motherboard 8 and the electromagnetic coil 5 are positioned in the hot-air zone, so that the present invention ensures that the hot air does not circle around and does not enter into the cold-air zone again to stay in the interior of the bottom housing 3 affecting cooling. The motherboard 5 and the electromagnetic coil 6 are heat generating elements. The bottom housing 3 divides the area where the control board 4 and the two fans are provided into a cold-air zone, and the area where the motherboard 5 and the electromagnetic coil 6 are provided into a hot-air zone by means of the first partition 306, the second partition 307, and the third partition 202. Cold air enters the interior of the bottom housing 3 through the vent opening on a side close to the fan, and is transformed into hot air after sufficiently contacting the motherboard 5 and the electromagnetic coil 6. Shortly thereafter, the hot air leaves the bottom housing 3 through the vent opening on the other side, so that heat dissipation of the electromagnetic coil 6 and the motherboard 5 may be achieved.

Specifically, referring to FIG. 1, an outer sidewall at the lower right corner of the bottom housing 3 is provided with a mounting groove penetrating from left to right, and a power line 14 is provided in the mounting groove. In practice, the power line 14 is connected to the control board 12, the motherboard 8, the electromagnetic coil 5, the first fan 9 and the second fan 10 in the wiring to provide operating power.

Specifically, referring to FIGS. 2, 6, and 8, the vent opening 4 includes a first air inlet 401 and a first air outlet 402, the first air inlet 401 is provided at a front side of the bottom housing 3, and the first air outlet 402 is provided at a rear side of the bottom housing 3. In practice, the first fan 9 and the second fan 10 may suck the air into their inner chambers from the first air inlet 401, and then spray the sucked-in air through the first opening to achieve the heat dissipation of the electromagnetic coil 5. Additionally, the air from the first fan 9 may be split and sprayed through the second opening to achieve the heat dissipation of the motherboard 8.

Specifically, referring to FIGS. 2, 6, and 8, a right sidewall of the bottom housing 3 is fixedly provided with a retainment plate 301 extending vertically upwards, and the retainment plate 301 and the curved wall are of integrally formed structure. The vent opening 4 further includes a second air inlet 403 and a second air outlet 404, both the second air inlet 403 and the second air outlet 404 are arranged back and forth along the right curved wall of the bottom housing 3, and the retainment plate 301 is provided between the second air inlet 403 and the second air outlet 404, so that hot and cold air may be separated. Effect: By setting up the second air inlet 403 and the second air outlet 404, the second fan 10 may also suck in the external air from the second air inlet 403, and then spray to the bottom of the electromagnetic coil 5. At this moment, besides the hot air may be blown out through the first air outlet 402, the hot air may be blown out through the second air outlet 404 when the first fan 9 is also activated and the air speed of the first fan 9 is relatively large. The multi-channel discharge of hot air may greatly improve the heat dissipation efficiency of the present invention.

Specifically, the electromagnetic coil 5 is provided with a plurality of through-holes penetrating up and down around the periphery of the electromagnetic coil 5, and the bottom housing 3 is fixedly provided with a first threaded column that may achieve a positioning fit with the through-holes, and the first threaded column passes upwardly through the through-holes to realize a detachable connection with the electromagnetic coil 6. Effect: The detachable fixation enables the replacement from old to new of the electromagnetic coil 5, thereby prolonging the service life of the induction hob.

Specifically, a plurality of second threaded columns extending vertically upwards are fixedly provided on the bottom housing 3, the plurality of second threaded columns are respectively wound around the side of the first fan 9 and the second fan 10, through-holes are respectively provided on the housing of the first fan 9 and the second fan 10 to achieve a positioning fit with the plurality of second threaded columns, the first fan 9 and the second fan 10 are provided on the bottom housing 3 via screw positioning. Effect: The screwing fixation enables the replacement from old to new of the first fan 9 and the second fan 10, thereby prolonging the service life of the induction hob.

Specifically, an inner periphery of the bottom housing 3 is provided with a plurality of positioning columns extending vertically upwards, the positioning column is provided with a stepped hole with an opening facing upwards, a side of the upper cover 2 facing the bottom housing 3 is provided with a plurality of columns, and the plurality of columns is in interference fit with a plurality of the stepped holes. Referring to FIG. 7, a bottom of the front panel 1 is flatted and fixed to a top of the upper cover 2.

The above described is preferred embodiments of the present disclosure. It should be noted that for those skilled in the art, a plurality of improvements and modifications may be made without departing from the principles of the present disclosure, which should also be considered as the scope of protection of the present disclosure.

1. A novel induction hob, comprising a front panel, an upper cover, and a bottom housing provided sequentially from top to bottom, wherein a sidewall of the bottom housing is gradually extended outwardly to form a curved wall, the curved wall is provided with a plurality of vent openings, an electromagnetic coil is provided within the bottom housing, an inner bottom of the bottom housing is provided with a flange extending vertically upwards around a periphery close to a sidewall of the bottom housing to block water from entering an interior of the bottom housing, a motherboard, a first fan, and a second fan are spaced around a side of the electromagnetic coil, the electromagnetic coil, the motherboard, the first fan, and the second fan are all positioned within a periphery of the flange, both the first fan and the second fan are provided with a first opening facing the electromagnetic coil, respectively, for heat dissipation of the electromagnetic coil, and the first fan is further provided with a second opening facing the motherboard for heat dissipation of the motherboard.

2. The novel induction hob according to claim 1, wherein the motherboard is fixedly provided with a heat dissipation sheet, and the heat dissipation sheet is provided on a side of the motherboard proximal to the first fan with the second opening for heat dissipation of the motherboard.

3. The novel induction hob according to claim 1, wherein an inner bottom surface of the bottom housing is further fixedly provided with a shield, and a position of the shield corresponds to that of the electromagnetic coil.

4. The novel induction hob according to claim 1, wherein a clearance is provided between an inner bottom surface of the bottom housing and a bottom surface of the electromagnetic coil.

5. The novel induction hob according to claim 1, wherein the flange is fixedly connected to the curved wall by reinforcing ribs.

6. The novel induction hob according to claim 1, wherein the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

7. The novel induction hob according to claim 2, wherein the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

8. The novel induction hob according to claim 3, wherein the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

9. The novel induction hob according to claim 4, wherein the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

10. The novel induction hob according to claim 5, wherein the bottom housing is fixedly provided with a first partition and a second partition extending vertically upwards, the first partition and the second partition divide an interior of the bottom housing into a cold-air zone and a hot-air zone, the first fan and the second fan are positioned in the cold-air zone, and the motherboard and the electromagnetic coil are positioned in the hot-air zone.

11. The novel induction hob according to claim 6, wherein a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot-air zone.

12. The novel induction hob according to claim 7, wherein a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot-air zone.

13. The novel induction hob according to claim 8, wherein a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot- air zone.

14. The novel induction hob according to claim 9, wherein a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot-air zone.

15. The novel induction hob according to claim 10, wherein a control board is provided within the bottom housing, the control board is provided closed to the motherboard, the bottom housing is fixedly provided with a first partition and a second partition extending vertically upwards, the first partition is provided between the first fan and the second fan, the second partition is provided between the control board and the motherboard, a side of the upper cover facing the bottom housing is fixedly provided with a third partition extending vertically downwards, a position of the third partition corresponds to those of the first partition and the second partition to separate a cold-air zone and a hot-air zone, the first fan, the second fan, and the control board are positioned in the cold-air zone, and the motherboard and the electromagnetic coil are positioned in the hot-air zone.

16. The novel induction hob according to claim 1, wherein the vent opening comprises a first air inlet and a first air outlet, the first air inlet is provided at a front side of the bottom housing, the first air outlet is provided at a rear side of the bottom housing, and both the first opening and the second opening are provided facing the first air outlet.

17. The novel induction hob according to claim 2, wherein the vent opening comprises a first air inlet and a first air outlet, the first air inlet is provided at a front side of the bottom housing, the first air outlet is provided at a rear side of the bottom housing, and both the first opening and the second opening are provided facing the first air outlet.

18. The novel induction hob according to claim 3, wherein the vent opening comprises a first air inlet and a first air outlet, the first air inlet is provided at a front side of the bottom housing, the first air outlet is provided at a rear side of the bottom housing, and both the first opening and the second opening are provided facing the first air outlet.

19. The novel induction hob according to claim 1, wherein a right sidewall and/or a left sidewall of the bottom housing is fixedly provided with a retainment plate extending vertically upwards, the vent opening is further provided with a second air inlet and a second air outlet, both the second air inlet and the second air outlet are provided on the right sidewall or the left sidewall of the bottom housing, the retainment plate is provided between the second air inlet and the second air outlet so as to divide an interior of the bottom housing into a cold-air zone and a hot-air zone, the second air inlet is positioned in the cold-air zone, and the second air outlet is positioned in the hot-air zone.

20. The novel induction hob according to claim 19, wherein the retainment plate is close to the second fan, and the retainment plate is extended from a sidewall of the bottom housing to the first opening of the second fan close to the retainment plate, so that the second fan is positioned in the cold-air zone.
